(19) United States
(12) Patent Application Publication
(10) Pub. No.: US 2011/0149020 A1
(43) Pub. Date: Jun. 23, 2011

(54) METHOD AND SYSTEM FOR VIDEO POST-PROCESSING BASED ON 3D DATA

(76) Inventors: Ilya Klebanov, Thornhill (CA); Xuemin Chen, Rancho Santa Fe, CA (US); Samir Hulyalkar, Newtown, PA (US); Marcus Kellerman, San Diego, CA (US)

(21) Appl. No.: 12/689,388

(22) Filed: Jan. 19, 2010

Related U.S. Application Data
(60) Provisional application No. 61/287,673, filed on Dec. 17, 2009.
(60) Provisional application No. 61/287,624, filed on Dec. 17, 2009.
(60) Provisional application No. 61/287,634, filed on Dec. 17, 2009.
(60) Provisional application No. 61/287,653, filed on Dec. 17, 2009.
(60) Provisional application No. 61/287,668, filed on Dec. 17, 2009.
(60) Provisional application No. 61/287,682, filed on Dec. 17, 2009.
(60) Provisional application No. 61/287,689, filed on Dec. 17, 2009.
(60) Provisional application No. 61/287,692, filed on Dec. 17, 2009.

(51) Int. Cl. H04N 13/00; H04N 5/91

(52) U.S. Cl. 348/42; 348/E13.001; 386/E05.003

(57) ABSTRACT

A media player may read three-dimensional (3D) video data comprising a plurality of view sequences of frames or fields from a media storage device, and may decimate one or more of the view sequences to enable transferring the video data to a display device. The media player may determine operational parameter(s) and/or transfer limitation(s) of a connecting subsystem used to transfer the video data to the display device. The decimation may be performed based on this determination of transfer limitation(s). The decimation may be performed temporally and/or spatially. The plurality of view sequences may comprise sequences of stereoscopic left and right view reference frames or fields. The decimation may be performed such that the removed data for each view sequence may be reconstructed, after reception, based on remaining data in the same view sequence and/or video data of other corresponding view sequences.

### CROSS-REFERENCE TO RELATED APPLICATIONS/INCORPORATION BY REFERENCE

This patent application makes reference to, claims priority to and claims benefit from U.S. Provisional Application Ser. No. 61/287,673 (Attorney Docket Number 20694US01) which was filed on Dec. 17, 2009. This application makes reference to:
U.S. Provisional Application Ser. No. 61/287,624 (Attorney Docket Number 20677US01) which was filed on Dec. 17, 2009;
U.S. Provisional Application Ser. No. 61/287,634 (Attorney Docket Number 20678US01) which was filed on Dec. 17, 2009;
U.S. application Ser. No. 12/554,416 (Attorney Docket Number 20679US01) which was filed on Sep. 4, 2009;
U.S. application Ser. No. 12/546,644 (Attorney Docket Number 20680US01) which was filed on Aug. 24, 2009;
U.S. application Ser. No. 12/619,461 (Attorney Docket Number 20681US01) which was filed on Nov. 6, 2009;
U.S. application Ser. No. 12/578,048 (Attorney Docket Number 20682US01) which was filed on Oct. 13, 2009;
U.S. Provisional Application Ser. No. 61/287,653 (Attorney Docket Number 20683US01) which was filed on Dec. 17, 2009;
U.S. application Ser. No. 12/604,980 (Attorney Docket Number 20684US02) which was filed on Oct. 23, 2009;
U.S. application Ser. No. 12/545,679 (Attorney Docket Number 20686US01) which was filed on Aug. 21, 2009;
U.S. application Ser. No. 12/560,554 (Attorney Docket Number 20687US01) which was filed on Sep. 16, 2009;
U.S. application Ser. No. 12/560,578 (Attorney Docket Number 20688US01) which was filed on Sep. 16, 2009;
U.S. application Ser. No. 12/560,592 (Attorney Docket Number 20689US01) which was filed on Sep. 16, 2009;
U.S. application Ser. No. 12/604,936 (Attorney Docket Number 20690US01) which was filed on Oct. 23, 2009;
U.S. Provisional Application Ser. No. 61/287,668 (Attorney Docket Number 20691US01) which was filed on Dec. 17, 2009;
U.S. application Ser. No. 12/573,746 (Attorney Docket Number 20692US01) which was filed on Oct. 5, 2009;
U.S. application Ser. No. 12/573,771 (Attorney Docket Number 20693US01) which was filed on Oct. 5, 2009;
U.S. Provisional Application Ser. No. 61/287,682 (Attorney Docket Number 20695US01) which was filed on Dec. 17, 2009;
U.S. application Ser. No. 12/605,039 (Attorney Docket Number 20696US01) which was filed on Oct. 23, 2009;
U.S. Provisional Application Ser. No. 61/287,689 (Attorney Docket Number 20697US01) which was filed on Dec. 17, 2009; and
U.S. Provisional Application Ser. No. 61/287,692 (Attorney Docket Number 20698US01) which was filed on Dec. 17, 2009.

Each of the above stated applications is hereby incorporated herein by reference in its entirety

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for video post-processing based on 3D data.

### BACKGROUND OF THE INVENTION

Display devices, such as television sets (TVs), may be utilized to output or playback audiovisual or multimedia streams, which may comprise TV broadcasts, telecasts and/or localized Audio/Video (AV) feeds from one or more available consumer devices, such as videocassette recorders (VCRs) and/or Digital Video Disc (DVD) players. TV broadcasts and/or audiovisual or multimedia feeds may be inputted directly into the TVs, or it may be passed intermediately via one or more specialized set-top boxes that may enable providing any necessary processing operations. Exemplary types of connectors that may be used to input data into TVs include, but not limited to, F-connectors, S-video, composite and/or video component connectors, and/or, more recently, High-Definition Multimedia Interface (HDMI) connectors.

Television broadcasts are generally transmitted by television head-ends over broadcast channels, via RF carriers or wired connections. TV head-ends may comprise terrestrial TV head-ends, Cable-Television (CATV), satellite TV head-ends and/or broadband television head-ends. Terrestrial TV head-ends may utilize, for example, a set of terrestrial broadcast channels, which in the U.S. may comprise, for example, channels 2 through 69. Cable-Television (CATV) broadcasts may utilize even greater number of broadcast channels. TV broadcasts comprise transmission of video and/or audio information, wherein the video and/or audio information may be encoded into the broadcast channels via one of plurality of available modulation schemes. TV Broadcasts may utilize analog and/or digital modulation format. In analog television systems, picture and sound information are encoded into, and transmitted via analog signals, wherein the video/audio information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable and/or satellite head-ends via discrete (digital) signals, utilizing one of available digital modulation schemes, which may comprise, for example, QAM, VSB, QPSK and/or OFDM. Because the use of digital signals generally requires less bandwidth than analog signals to convey the same information, DTV systems may enable broadcasters to provide more digital channels within the same space otherwise available to analog television systems. In addition, use of digital television signals may enable broadcasters to provide high-definition television (HDTV) broadcasting and/or to provide other non-television related service via the digital system. Available digital television systems comprise, for example, ATSC, DVB, DMB-T/H and/or ISDN based systems. Video and/or audio information may be encoded into digital television signals utilizing various video and/or audio encoding and/or compression algorithms, which may comprise, for example, MPEG-1/2, MPEG-4 AVC, MP3, AC-3, AAC and/or HE-AAC.

Nowadays most TV broadcasts (and similar multimedia feeds), utilize video formatting standards that enable communication of video images in the form of bit streams. These video standards may utilize various interpolation and/or rate conversion functions to present content comprising still and/or moving images on display devices. For example, de-interlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for video post-processing based on 3D data, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video system that may provide communication of 3D video, in accordance with an embodiment of the invention.

FIG. 2A is a block diagram illustrating an exemplary video processing system that may be operable to generate video content comprising 3D video, in accordance with an embodiment of the invention.

FIG. 2B is a block diagram illustrating an exemplary video processing system that may be operable to receive and process video content comprising 3D video for display from media storage devices, in accordance with an embodiment of the invention.

FIG. 3A is a flow chart that illustrates exemplary steps for video processing of multimedia data comprising 3D video content via a media player, in accordance with an embodiment of the invention.

FIG. 3B is a flow chart that illustrates exemplary steps for video processing of multimedia data comprising decimated 3D video content received from a media player, in accordance with an embodiment of the invention.

### DETAILED DESCRIPTION OF THE INVENTION

Certain embodiments of the invention may be found in a method and system for video post-processing based on 3D data. In various embodiments of the invention, a media player may retrieve multimedia data comprising three-dimensional (3D) video content corresponding to a plurality of view sequences of frames or fields from a media storage device. The media player may determine operational parameter(s) and/or transfer limitation(s) of a connecting subsystem utilized to transfer the video content to a display device, and may remove some video data corresponding to one or more of the view sequences to enable transferring the video content to the display device. The connecting subsystem may comprise one or more High-Definition Multimedia Interface (HDMI) based connections. The media storage device may comprise one or more Blu-ray discs. The video data may be removed by decimating and/or sampling the one or more view sequences. The decimation may be performed temporally and/or spatially. The decimation may be performed such that the removed data for each view sequence may be reconstructed, after reception, based on remaining data in the same view sequence and/or video data of other corresponding view sequences. The plurality of view sequences may comprise sequences of stereoscopic left and right view reference frames or fields. Accordingly, during temporal decimation of the sequences of stereoscopic left and right views, video data for corresponding frames may be decimated. Alternatively, during temporal decimation of the sequence of stereoscopic left and right views, video data for alternating frames of the right and left view sequences may be decimated. During spatial decimation of the sequences of stereoscopic left and right views, top or bottom fields in each frame of the sequences of stereoscopic left and right views. The decimated 3D video content may be processed after reception to generate 3D output video streams suitable for playback via the display device. Processing the decimated video data after reception may comprise reconstructing removed video data for each view sequence, and the 3D video output streams may be generated based on the reconstructed view sequences.

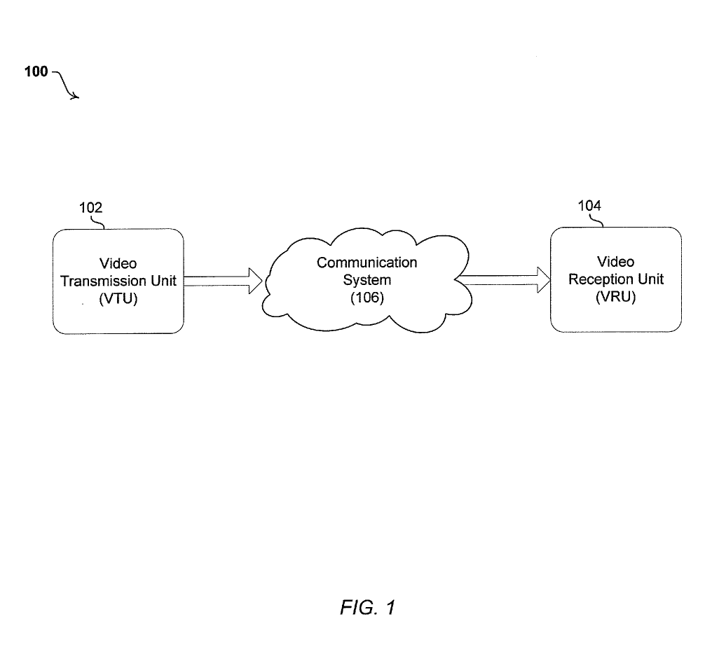

FIG. 1 is a block diagram illustrating an exemplary video system that may provide communication of 3D video, in accordance with an embodiment of the invention. Referring to FIG. 1, there is shown a system 100 comprising a video transmission unit (VTU) 102, a video reception unit (VRU) 104, and a communication system 106.

The VTU 102 may comprise suitable logic, circuitry, interfaces and/or code that may be operable to provide encoded and/or compressed video data, via the communication system 106 for example, to the VTU 104 to facilitate display and/or video playback operations. In an exemplary aspect of the invention, the VTU 102 may be operable to encode 3D video contents as well as 2D video contents. For example, in instances where 3D video content is generated as stereoscopic 3D video, the VTU 102 may be operable to encode the 3D video as a left view video sequence and a right view video sequence, of which each may be transmitted in a different channel to the VRU 130. The video content generated via the VTU 102 may be broadcasted to the VRU 104 via the communication system 106. Accordingly, the VTU 102 may comprise a terrestrial-TV head-end, a cable-TV (CATV) head-end, a direct broadcast satellite head-end, and/or a web server that may provide broadband-TV transmission via the Internet, for example. Alternatively, the video content may be stored into multimedia storage devices, such as DVD or Blu-ray discs, which may be distributed via the communication system 106 for playback via the VRU 104.

The VRU 104 may comprise suitable logic, circuitry, interfaces and/or code that may be operable to receive and/or process video contents that may comprise 3D video. The video content may be received, by the VRU 104, in the form of transport streams, which may be communicated directly by, the VTU 102 for example, via TV broadcasts. The transport stream may comprise encoded 3D video corresponding to, for example, stereoscopic 3D video sequences. In this regard, the VRU 104 may be operable to demultiplex or parse the received transport stream, based on user profile, user input, and/or predetermined configuration parameter(s), for example. The encoded stereoscopic 3D video sequences may be extracted from the received transport stream and may be stored in a memory or a local storage of VRU 104. The VRU 104 may be operable to decode the extracted encoded stereoscopic 3D video sequences for display. The VTU 104 may also be operable to receive and/or process video content communicated by the VTU 102 via multimedia storage devices, such as DVD or Blu-ray discs. In this regard, the VRU 104 may comprise an appropriate audio/video (AV) player device and/or subsystem, such as Blu-ray player or DVD player, which may enable reading video data from the multimedia storage devices. In some instances, the VRU 104 may be operable to convert 3D video into a 2D video for display. Examples of the VRU 104 may comprise set-top boxes, personal computers, television sets, AV player, or any combination thereof.

The communication system 106 may comprise suitable logic, circuitry, interfaces and/or code that may be operable to provide platforms and/or mediums for communicating video data between the VTU 102 and the VRU 104. In instances where the video data is communicated directly, via TV broadcasts for example, the communication system 106 may comprise one or more wired and/or wireless networks. In this regard, the communication system 106 may be local area network, wide area network, the Internet, and the like. In instances where the video data is communicated indirectly, the communication system 106 may comprise support infrastructure that may be enable storing video data into media storage devices, such as DVD and/or Blu-ray discs, which may then be distributed to end-users. The media storage devices may then be read via appropriate AV player devices, such DVD or Blu-ray players for example, to enable retrieving the video data that may be played back locally via a display device, such as a HDTV set.

In operation, the VTU 102 may be operable to generate, encode and/or compress video content, which may then be communicated to the VRU 104, via the communication system 106. The VTU 104 may be operable to receive and process the video content to facilitate display and/or playback operations via appropriate display devices. In this regard, the VTU 104 may be operable to, for example, demultiplex received transport streams to extract encoded video content, and to decode/decompress the video content and to process the decoded video content such that video may be suitable for local display.

In exemplary aspect of the invention, the media system 100 may be operable to support three-dimensional (3D) video. Recently, there has been a push towards the development and/or use of three-dimensional (3D) video instead of 2D video. Various methods may be utilized to capture, generate (at capture or playtime), and/or render 3D video images. One of the more common methods for implementing 3D video is stereoscopic 3D video. In stereoscopic 3D video based application the 3D video impression is generated by rendering multiple views, most commonly two views: a left view and a right view, corresponding to the viewer's left eye and right eye to give depth to displayed images. In this regard, left view and right view video sequences may be captured and/or processed to enable creating 3D images. The left view and right view data may then be communicated either as separate streams, or may be combined into a single transport stream and only separated into different view sequences by the end-user receiving/displaying device. The communication of stereoscopic 3D video may be by means of TV broadcasts. In this regard, the VTU 102 may be operable to transmit the 3D video content via a plurality of wired and/or wireless connections that facilitate terrestrial-TV, cable-TV (CATV), satellite-TV, and/or broadband-TV based transmissions. The communication of stereoscopic 3D video may also be performed by use of multimedia storage devices, such as DVD or Blu-ray discs, which may be used to store 3D video data that subsequently may be played back via an appropriate player. Various compression/encoding standards may be utilized to enable compressing and/or encoding of the view sequences into transport streams during communication of stereoscopic 3D video. For example, the separate left and right view video sequences may be compressed based on MPEG-2 MVP, H.264 and/or MPEG-4 advanced video coding (AVC) or MPEG-4 multi-view video coding (MVC).

In various embodiments of the invention, in instances where the video content is communicated via multimedia storage devices, the video content may be processed via a media player used to read the video content to facilitate local transfer of the video data to the playback/display device. For example, in instances where the video content is stored into Blu-ray discs, a combination of Blu-ray player and a playback/display system, which may comprise a HDTV set, to facilitate playback operations. The Blu-ray player may read the video content, and may transfer the video content, via a High-Definition Multimedia Interface (HDMI) based connection to the playback/display system. Most of the presently used video transport and/or connection infrastructure may be tailored to 2D video. Accordingly, in instances where the video content comprises 3D video, the transport of 3D video content may pose some problems during communication of the video content using current transport and/or connecting systems and/or interfaces. For example, where 3D video content comprises a plurality of stereoscopic views, each of the view sequences may be captured and/or generated at the upper limits of the 2D video support infrastructure, thus causing various issues, such as bandwidth limitation(s) for example, during transfer of 3D video data. Current video data transfer infrastructure may be tailored to, for example, 2D video operating at most in the 1080p60 mode. Accordingly, where each of 3D video stereoscopic view sequences is captured individually, and stored into the multimedia storage devices, as 1080p60 video, the bandwidth required for transferring corresponding 3D video content from the media player to the playback/display system may require transfer bandwidth that may be multiple of the maximum bandwidth currently utilized and/or supported during video transfer, via HDMI cables for example. Accordingly, in an exemplary aspect of the invention, the 3D video content read via the media player may be processed to reduce total size of video data transferred to the playback/display system. Additionally, once received via the playback/display system, the removed video data may then be reconstructed. During reconstruction operations on each view sequence, video data from remaining view sequences may be utilized to estimated and/or simulate removed data.

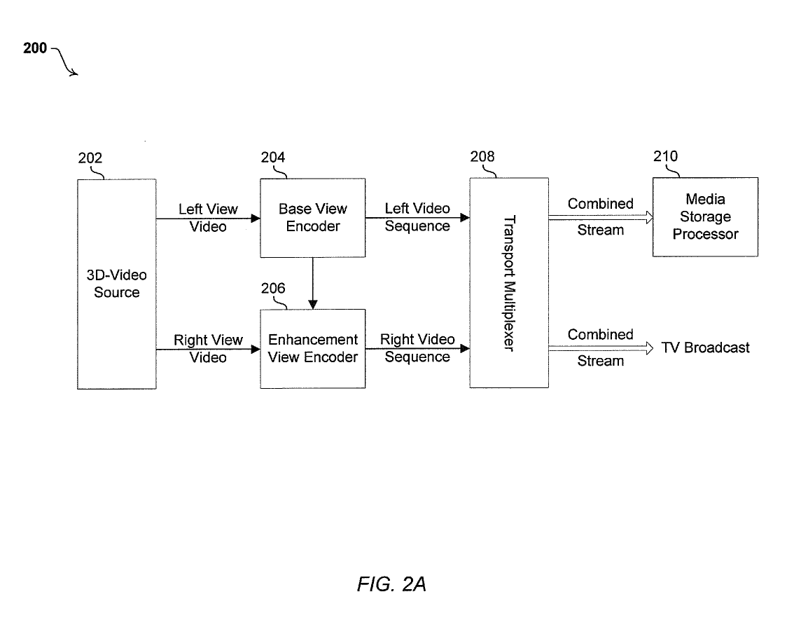

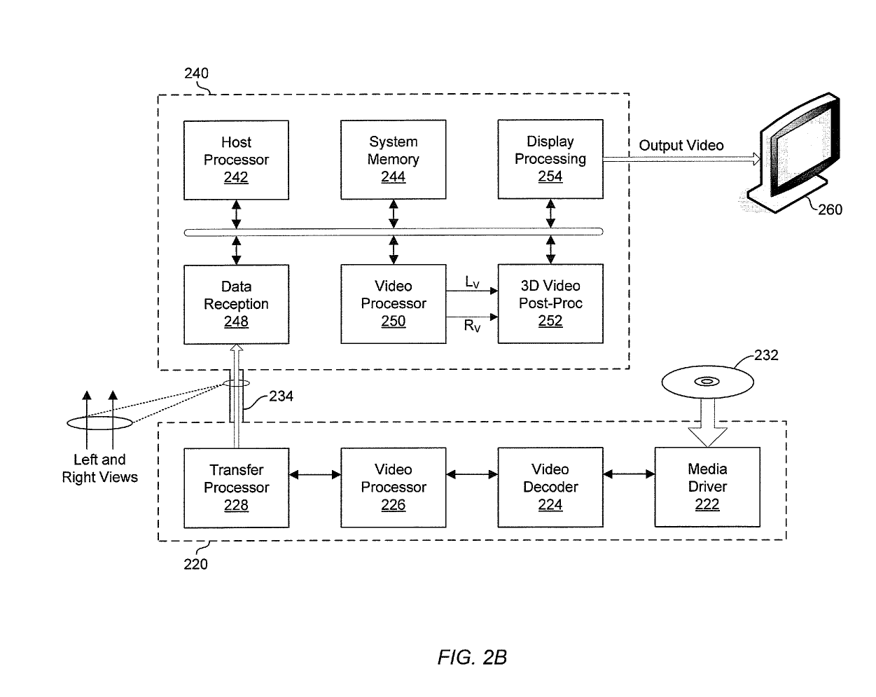

FIG. 2A is a block diagram illustrating an exemplary video processing system that may be operable to generate video content comprising 3D video, in accordance with an embodiment of the invention. Referring to FIG. 2A, there is shown there is shown a video processing system 200, a 3D-video source 202, a base view encoder 204, an enhancement view encoder 206, a transport multiplexer 208, and media storage processor 210.

The video processing system 200 may comprise suitable logic, circuitry, interfaces and/or code that may be operable to capture, generate, and/or process video data, comprising 2D and/or 3D video, and/or to generate corresponding transport streams comprising the video content. The video processing system 200 may comprise, for example, the 3D-video source 202, the base view encoder 204, the enhancement view encoder 206, and/or the transport multiplexer 208. The video processing system 200 may be integrated into the VTU 102 to facilitate generation of video and/or transport streams comprising 3D video data. Generated transport streams may be communicated directly to end-users, via TV broadcasts for example. Alternatively, the resultant transport streams may be stored into multimedia storage devices, such as Blu-ray discs, via the media storage processor 210.

The 3D-video source 202 may comprise suitable logic, circuitry, interfaces and/or code that may be operable to capture and/or generate source 3D video contents. The 3D-video source 202 may be operable to generate stereoscopic 3D video comprising left view and right view video data from the captured source 3D video contents, to facilitate 3D video display/playback. The left view video and the right view video may be communicated to the base view encoder 204 and the enhancement view encoder 206, respectively, for video compressing.

The base view encoder 204 may comprise suitable logic, circuitry, interfaces and/or code that may be operable to encode the left view video from the 3D-video source 202, for example on frame by frame basis. The base view encoder 204 may be operable to utilize various video encoding and/or compression algorithms such as those specified in MPEG-2, MPEG-4, AVC, VC1, VP6, and/or other video formats to form compressed and/or encoded video contents for the left view video from the 3D-video source 202. In addition, the base view encoder 204 may be operable to communication information, such as the scene information from base view coding, to the enhancement view encoder 206 to be used for enhancement view coding.

The enhancement view encoder 206 may comprise suitable logic, circuitry, interfaces and/or code that may be operable to encode the right view video from the 3D-video source 202, for example on frame by frame basis. The enhancement view encoder 206 may be operable to utilize various video encoding and/or compression algorithms such as those specified in MPEG-2, MPEG-4, AVC, VC1, VP6, and/or other video formats to form compressed or encoded video content for the right view video from the 3D-video source 202. Although a single enhancement view encoder 206 is illustrated in FIG. 2B, the invention may not be so limited. Accordingly, any number of enhancement view video encoders may be used for processing the left view video and the right view video generated by the 3D-video source 202 without departing from the spirit and scope of various embodiments of the invention.

The transport multiplexer 208 may comprise suitable logic, circuitry, interfaces and/or code that may be operable to merge a plurality of video sequences into a single compound video stream. The combined video stream may comprise the left (base) view video sequence, the right (enhancement) view video sequence, and a plurality of addition video streams, which may comprise, for example, advertisement streams.

The media storage processor 210 may comprise suitable logic, circuitry, interfaces, and/or code that may enable storing video content, of the combined video stream for example, into one or more multimedia storage devices, such as Blu-ray discs. In this regard, the media storage processor 210 may be operable to format and/or process data such that the formatted data may be stored in, for example, Blu-ray discs. In certain embodiments, the media storage processor 210 may be operable to store the view sequences direct thus skipping generation of the combined video streams via the transport multiplexer 208.

In operation, the 3D-video source 202 may be operable to capture and/or generate source 3D video contents to produce, for example, stereoscopic 3D video data that may comprise a left view video and a right view video for video compression. The left view video may be encoded via the base view encoder 204 producing the left (base) view video sequence. The right view video may be encoded via the enhancement view encoder 206 to produce the right (enhancement) view video sequence. The base view encoder 204 may be operable to provide information such as the scene information to the enhancement view encoder 206 for enhancement view coding, to enable generating depth data, for example. Transport multiplexer 208 may be operable to combine the left (base) view video sequence and the right (enhancement) view video sequence to generate a combined video stream. Additionally, one or more additional video streams (not shown) may be multiplexed into the combined video stream via the transport multiplexer 208. The additional video streams may comprise such information as advertising information, and/or in instances where the combined stream is stored into multimedia storage devices, video data that may be utilized to enable user interactions during playback.

In some instances, the video content generated and/or captured via the video processing system 200 maybe stored into multimedia storage devices. In this regard, the combined stream may be forward to the media storage processor 210, which may then format and/or process a combined stream such that the resulted formatted data may be stored into, for example, Blu-ray discs. The view sequences may also be stored separately. In this regard, the media storage processor 210 may also received view sequences directly, thus skipping generation of the combined video streams via the transport multiplexer 208. Each of the view sequences may then be formatted to enable writing the corresponding formatted data to the multimedia storage device.

FIG. 2B is a block diagram illustrating an exemplary video processing system that may be operable to receive and process video content comprising 3D video for display from media storage devices, in accordance with an embodiment of the invention. Referring to FIG. 2B there is shown a media player 220, a media driver 222, a video decoder 224, a video processor 226, a transfer processor 228, a media storage device 232, a connecting subsystem 234, a video processing device 240, a host processor 242, a system memory 244, a data reception module 248, a video processor 250, a 3D video post-processing module 252, a display processing module 254, and a display 260.

The media storage device 232 may comprise a storage device which may be utilized to store multimedia data comprising video content. Exemplary media storage devices may comprise digital video discs (DVDs), video compact discs (VCDs), High-Definition DVDs (HD-DVD), and/or Blu-ray discs. The connecting subsystem 234 may comprise suitable logic, circuitry, interfaces and/or code that may be operable to. In this regard, the connecting subsystem may comprise, for example, a High-Definition Multimedia Interface (HDMI) connection between the media player 220 and the video playback system 240.

The media player 220 may comprise suitable logic, circuitry, interfaces and/or code that may enable reading multimedia data, comprising video content for example, which may be stored in one or more types of storage devices. The media player 220 may comprise, for example, a Blu-ray player. The media player 220 may comprise, for example, the media driver 222, the video decoder 224, the video processor 226, the transfer processor 228.

The media driver 222 may comprise suitable logic, circuitry, interfaces and/or code that enable interfacing with storage devices of particular type, to facilitate reading and/or writing of data from and/or to the storage devices. The media driver 222 may comprise, for example, spinning and/or actuator circuitry that enable physical interactions with media storage devices, for example Blu-ray discs, such that data stored into the media storage devices may be read out.

The video decoder 224 may comprise suitable logic, circuitry, interfaces and/or code that may be operable to process encoded video data. In this regard, the video decoder 224 may be operable to decompress and/or decoded video content which may stored, as compressed/encoded data, in the media storage device 232. The video decoder 224 may also perform additional security operations such as digital rights management (DRM). The compressed video data read from the media storage device 232 may comprise 3D video data corresponding to a plurality of view stereoscopic video sequences of frames or fields, such as left and review views. The video data may be compressed and/or encoded via MPEG-2 transport stream (TS) protocol or MPEG-2 program stream (PS) container formats, for example. In various embodiments of the invention, the left view data and the right view data may be stored as separate streams or files. In this instance, the video decoder 224 may decompress the received separate left and right view video data based on, for example, MPEG-2 MVP, H.264 and/or MPEG-4 advanced video coding (AVC) or MPEG-4 multi-view video coding (MVC). In other instances, the stereoscopic left and right views may be combined into a single sequence of frames. For example, side-by-side, top-bottom and/or checkerboard lattice based 3D encoders may convert frames from a 3D stream comprising left view data and right view data into a single-compressed frame and may use MPEG-2, H.264, AVC and/or other encoding techniques. In this instance, the video data may be decompressed by the video decoder 224 based on MPEG-4 AVC and/or MPEG-2 main profile (MP), for example.

The video processor 226 may comprise suitable logic, circuitry, interfaces and/or code that may be operable to perform video processing operations on video content extracted from multimedia data read from media storage devices, such the media storage device 232. In an exemplary aspect of the invention, the video processor 226 may be operable to extract a plurality of view sequences from the video content corresponding to 3D video. The video processor 226 may also decimate and/or sample the extracted view sequences to facilitate transfer of the video content to the video playback system 240 via the connecting subsystem 234, for example where the bitrate required to transfer the un-decimated video content exceed the limits of the connecting subsystem 234.

The transfer processor 228 may comprise suitable logic, circuitry, interfaces and/or code that may be operable to provide interfacing functionality between the media player 220 and the connecting subsystem 234, to facilitate transfer of the video content, which may be read from the media storage device 232, to the video playback system 240. In this regard, the transfer processor 228 may support HDMI based connections, for example. In an exemplary aspect of the invention, the transfer processor 228 may determine operational limitation(s), such as transfer bandwidth, for communicating video content via the connecting subsystem 234. The transfer processor 228 may then generate and/or provide control information and/or signals, to the video processor 226, based on that determination, to facilitate any necessary decimation and/or sampling.

The video playback system 240 may comprise suitable logic, circuitry, interfaces and/or code that may be operable to receive and/or process video content to facilitate video display and/or playback operations via the display 260. The video playback system 240 may comprise, for example, the host processor 242, the system memory 244, the data reception module 248, the video processor 250, and/or the display processing module 254.

The host processor 242 may comprise suitable logic, circuitry, interfaces and/or code that may be operable to process data and/or control operations of the video playback system 240. In this regard, the host processor 242 may be operable configure and/or controlling operations of various other components and/or subsystems of the video playback system 240, by providing, for example, control signals to various other components and/or subsystems of the video playback system 240. The host processor 242 may also control data transfers within the video playback system 240, during video processing operations for example. The host processor 242 may enable execution of applications, programs and/or code, which may be stored in the system memory 244, to enable, for example, performing various video processing operations such as decompression, motion compensation operations, interpolation or otherwise processing 3D video data. The system memory 244 may comprise suitable logic, circuitry, interfaces and/or code that may operable to store information comprising parameter(s) and/or code that may effectuate the operation of the video playback system 240. The parameter(s) may comprise configuration data and the code may comprise operational code such as software and/or firmware, but the information need not be limited in this regard. Additionally, the system memory 244 may be operable to store 3D video data, for example, data that may comprise left and right views of stereoscopic image data.

The data reception module 248 may comprise suitable logic, circuitry interfaces and/or code that may be operable to provide interfacing functionality between the video playback system 240 and the connecting subsystem 234, to facilitate reception of video content, which may be read from the media storage device 232, via the media player 220. In this regard, the transfer processor 228 may support, for example, HDMI based connections. In an exemplary aspect of the invention, in instances where the received video content corresponds to 3D video, the data reception module 248 may buffer the 3D video data, comprising left and/or right view sequences for example, while it is being received. In this regard, the data reception module 248 may receive the 3D video data from the connecting subsystem 234, and may then transfer data directly to the video processor 250, for example, for further processing, and/or may transfer the received 3D video data to the system memory 244 for further buffering while the 3D video content is processed via the video playback system 240.

The video processor 250 may comprise suitable logic, circuitry, interfaces and/or code that may be operable to perform video processing operations on received video data to facilitate generating corresponding output video streams, which may be played via the display 260. The video processor 250 may be operable, for example, to generate video frames that may provide 3D video playback via the display 260 based on a plurality of view sequences extracted from the received transport streams. In this regard, the video processor 250 may utilize the video data, such as luma and/or chroma data, in the received view sequences of frames and/or fields. In addition, the data reception module 248 may buffer decompressed reference frames and/or fields, for example, during frame interpolation, by the display processing module 254, and/or contrast enhancement processing operations. The data reception module 248 may exchange control signals with the host processor 242 for example and/or may write data to the system memory 244 for longer term storage.

The 3D video post-processing module 252 may comprise suitable logic, circuitry, interfaces and/or code that may be operable to process video content received from the media player 220, to reconstruct video data that may have been removed by the media player 20 to facilitate transfer of the video content via the connecting subsystem 234. In this regard, the 3D video post-processing module 252 may estimate and/or reconstruct video data that may have been removed from 3D video content received via the media player 220, based on, for example, remaining video data.

The display processing module 254 may comprise suitable logic, circuitry, interfaces and/or code that may be operable to process video data generated and/or processed via the video playback system 240 to generate an output video stream that is suitable for playback via the display 260. In this regard, the display processing module 254 may perform, for example, frame upconversion based on motion estimation and/or motion compensation to increase the number of frames where the display 260 has higher frame rate than the input video streams. In instances where the display 260 is not 3D capable, to convert 3D video data generated and/or processed via the video playback system 240 to 2D output video. In this regard, the 3D video converted to 2D output stream may comprise blended 3D input video and 3D graphics.

The display 260 may comprise suitable logic, circuitry, interfaces and/or code that may be operable to receive reconstructed fields and/or frames of video data after processing in the display processing module 254 and may display corresponding images. The display 260 may be a separate device, or the display 260 and the video playback system 240 may implemented as single unitary device. The display 260 may be operable to perform 2D and/or 3D video display. In this regard, a 2D display may be operable to display video that was generated and/or processed utilizing 3D techniques.

In operation, the media player 220 and/or the video playback system 240 may be used to process multimedia data comprising video content, and/or to generate output video streams which are playable via, for example, the display 260. The media player 220, the video playback system 240, and/or the display 260 may correspond to and/or may be integrated into the VTU 104 to facilitate processing of 3D video content communicated by the VTU 102. In processing video content read from the media storage device 232, the media player 220 and/or the video playback system 240 may handle interlaced video fields and/or progressive video frames. In this regard, the media player 220 and/or the video playback system 240 may decompress and/or upconvert interlaced video and/or progressive video. The interlaced video fields, for example, and/or the progressive video frames may be referred to as fields, video fields, frames or video frames. In instances where a plurality of view sequence are multiplexed within a single transport stream, the media player 220 may demultiplex the transport stream to extract plurality of compressed video, which may correspond to, for example, view sequences and/or additional information. Demultiplexing the transport stream may be performed within the video decoder 224, or via a separate component (not shown). In instances where the 3D video content comprises compressed stereoscopic 3D video data, in multi-view compression format for example, and to decode and/or decompress that video data. For example, transport streams may comprise left and right stereoscopic views. The video decoder 224 may decompress and/or decode the received stereoscopic video data. The decompressed video data may then be processed, via the media player 220 and/or the video playback system 240, to enable playback via the display 260.

In various embodiments of the invention, the media player 220 may be operable to process video content that may be read from the media storage device 232 to enable communicating the video content to the video playback system 240 via the connecting subsystem 234. During any such processing, the media player 220 may remove a portion of the video content retrieved from the media storage device 232 to reduce the size of data that may need to be transferred to the video playback system 240 via the connection system 234. In this regard, the multimedia data read via the media driver 222 from the media storage device 232 may comprise 3D video content, which may comprise, for example, a plurality of view sequences of frames or fields, such as right and left views in stereoscopic 3D video. Accordingly, the view sequences may be extracted during video decoding operations in the video decoder 224. The media player 220 may decimate and/or sample, via the video processor 226 for example, one or more view sequence to facilitate the data removal. The decimation and/or sampling may be performed based on determination of transfer limitation(s), such as maximum allowable bandwidth, of the connecting subsystem 234 via the transfer processor 228. For example, present HDMI connections maybe tailored to support, at most, 1080p60 2D video. Therefore, in instances where the 3D video content comprises stereoscopic left and right view sequences, each of which was created and/or generated as 1080p60 video, the video content corresponding to both sequences would necessitate bandwidth that is twice of the maximum bandwidth available via the connecting subsystem 234. Accordingly, some of the video data corresponding to one or more view sequences may be removed. For example, in instances where the 3D video content comprises stereoscopic left and right view sequences, each of the view sequences may be decimated to reduce the size of video data corresponding to each of these view sequences. The decimation may be performed spatially (i.e., within each frame) and/or temporally (i.e., in plurality of frames). The right and left view sequences may be subjected to horizontal sampling, for example, wherein some of the video data, corresponding to pixels in each frame, may be removed.

To ensure quality of the 3D video displayed, the decimation and/or sampling operations may be performed such that remaining data in the each view sequences and/or in other view sequences may be utilized, via the video playback system 240 for example, to estimate and/or reconstruct the removed data. For example, alternating pixels, rows, fields, and/or frames may be decimated, by the video processor 226, in the left and right views such that the total size of the video content for both views may be reduced, for example, by half. The video content may then be transferred via the connecting subsystem 234, and may be received by the video playback system 240 via the data reception module 248. The video content may be processed, via the video processor 250 and/or the 3D video post-processing module 252, to generate output video streams which may be 3D and/or 2D, based on received video data for playback via the display 260. In this regard, where stereoscopic 3D video is utilized, the video processor 250 may process decompressed reference frames and/or fields, corresponding to plurality of view sequences such as right and left views, which may be received via the data reception module 248, to enable generation of corresponding 3D output video steams that may be further processed via the 3D video post-processing module and/or the display processing module 254 prior to playback via the display 260. For example, the 3D video post-processing module 252 may blend decimated and/or sampled right and left views estimating and/or reconstructing, for example, removed video data for decimated pixels, rows, fields, and/or frames in each view (e.g. left view sequence) based on video data for existing corresponding pixels, rows, fields, and/or frames of the corresponding view (e.g. right view sequence). During such reconstruction and/or estimation operations, by the 3D video post-processing module 252, on one view (e.g. left view), received video data for another view (e.g. right view) may be adjusted to account for variations in, for example, viewing angles, between the left and right views for example. The viewing angles may be preconfigured, based on the predetermined viewing angles between the left and right eyes. The viewing angles may also be adjusted, by the video processor 250 for example, based on user input, which may provided prior to start of 3D video playback and/or dynamically during 3D video playback. In some embodiments of the invention, information utilized for reconstruction, such as viewing angles may be embedded in the 3D video content stored in the media storage device 232.

The display processing module 254 may then perform any necessary final adjustment to ensure that output video stream may be played back via the display 260. For example, where necessary the display processing module 254 may perform motion compensation and/or may interpolate pixel data in one or more frames between the received frames in order to enable the frame rate up-conversion. The viewing controller 252 may be utilized to provide local graphics processing, to enable splicing, for example, graphics into the generated and enhanced video output stream, and the final video output stream may then be played via the display 260.

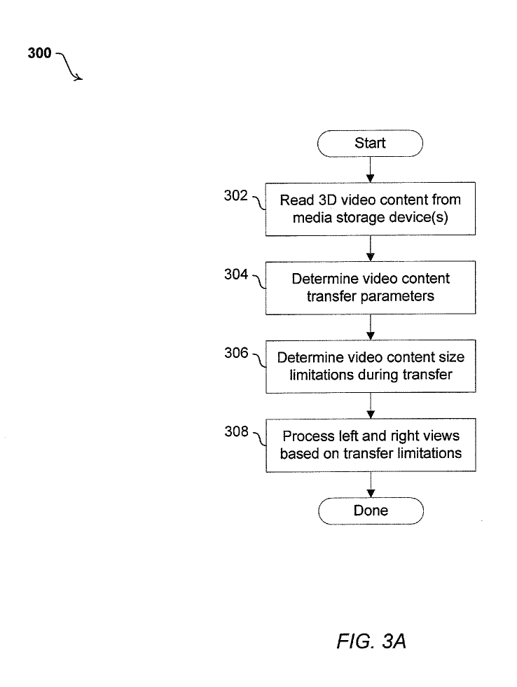

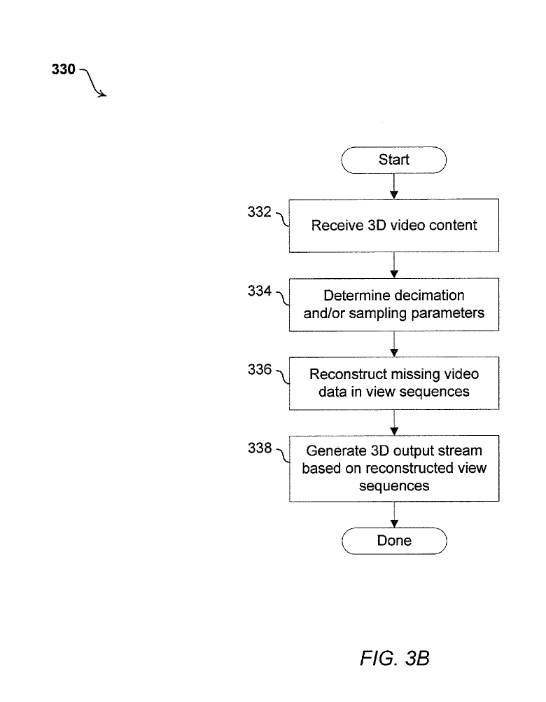

FIG. 3A is a flow chart that illustrates exemplary steps for video processing of multimedia data comprising 3D video content via a media player, in accordance with an embodiment of the invention. Referring to FIG. 3A, there is shown a flow chart 300 comprising a plurality of exemplary steps that may be performed to enable processing 3D content read from media storage devices.

In step 302, 3D video content which may be stored in media storage device may be retrieved. For example, the media player 220 may be operable to retrieved, via the media driver 222, multimedia data comprising video content, including 3D video, which may have been previously stored into the media storage device 232. In step 304, transfer parameter(s) and/or limitation(s) may be determined. For example, the transfer processor 228 may be operable to determine the operational parameter(s) of the connecting subsystem 234, which subsequently may be used to transfer the video content to the video playback system 240. In step 306, video content size limitation(s) during transfer may be determined. For example, the transfer processor 228 may determined, based on determination of the operational parameter(s) of the connecting subsystem 234, any transfer limitation(s) on transferring video content between the video player 220 and the video playback system 240. For example, the transfer processor 228 may determine the maximum bandwidth that may be available during communication of 3D video content via the connecting subsystem 234. In step 308, 3D video content based on transfer limitation(s). For example, in instances where the 3D video content comprises plurality of view sequences, such as left and right views, the video processor 226 may remove some of video data corresponding to the left and/or right view sequences such that the resultant video data may be communicated via the connecting subsystem 234. In this regard, the right and/or right views may be decimated and/or sampled, substantially as described with regard to FIG. 2B. The decimated video content may then be transferred to the video playback system 240 via the connecting subsystem 234.

FIG. 3B is a flow chart that illustrates exemplary steps for video processing of multimedia data comprising decimated 3D video content received from a media player, in accordance with an embodiment of the invention. Referring to FIG. 3B, there is shown a flow chart 330 comprising a plurality of exemplary steps that may be performed to enable video post-processing of 3D video content read and decimated by a media player.

In step 332, 3D video content, which may have been decimated and/or sampled, may be received. For example, the video playback system 240 may receive, via the data reception module 248, video content sent by the media player 220 via the connecting subsystem 234. In step 334, data reduction parameter(s) and/or more may be determined. For example, the video processor 250 and/or the 3D video post-processing module 252 may determined whether video data corresponding to right and/or right view sequence have been decimated and/or sampled, and/or decimation and/or sampling parameter(s). In step 336, removed video data may be reconstructed. For example, the 3D video post-processing module 252 may estimate and/or reconstruct video data of one or more view sequences which have been removed by the media player 220. The 3D video post-processing module 252 may utilize, during estimation and/or reconstruction operations on each view sequence, remaining video data in the view sequence and/or in other corresponding view sequences. Additional information, such as view angle related information for example, may also be utilized during the estimation and/or reconstruction operations. In step 338, corresponding 3D output stream, based on reconstructed view sequences, may be generated, for playback via the display 260 for example.

Various embodiments of the invention may comprise a method and system for video post-processing based on 3D data. The media player 220 may retrieve, via the media driver 222, multimedia data from the media storage device 232, which may comprise three-dimensional (3D) video content corresponding to a plurality of view sequences of frames or fields. The media player 220 may determine, via the transfer processor 228, operational parameter(s) and/or transfer limitation(s) of a connecting subsystem 234, which may be utilized to transfer the 3D video content to the video playback system 240 for video playback via the display 260. The connecting subsystem 234 may comprise one or more High-Definition Multimedia Interface (HDMI) based connections. The media storage device 232 may comprise one or more Blu-ray discs. The video data may be removed by decimating and/or sampling the one or more view sequences. The media player 220 may remove, via the video processor 226, at least a portion of video data corresponding to one or more of the view sequences to enable transferring the 3D video content to the display 260. The data removing may be based on the transfer limitation(s) of the connecting subsystem 234, and may be achieved using decimation and/or sampling. The decimation may be performed temporally and/or spatially. In this regard, view sampling and/or decimation may be performed such that the removed data for each view sequence may be reconstructed, after reception by the video playback system 240, based on remaining data in the same view sequence and/or video data of other corresponding view sequences. The plurality of view sequences may comprise sequences of stereoscopic left and right view reference frames or fields. Accordingly, during temporal decimation of the sequences of stereoscopic left and right views, video data for corresponding frames may be decimated. Alternatively, during temporal decimation of the sequence of stereoscopic left and right views, video data for alternating frames of the right and left view sequences may be decimated. During spatial decimation of the sequences of stereoscopic left and right views, top or bottom fields in each frame of the sequences of stereoscopic left and right views. After the decimated 3D video content is received by the video playback system 240, via the reception module 248, the 3D video content may be processed, via the video processor 250 and/or the 3D video post-processing module 252, to generate 3D output video streams. Removed video data may be reconstructed, during that processing, based on remaining video data and/or other view sequences, such that the generated 3D output stream may be suitable for playback via the display 260.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for video post-processing based on 3D data.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
performing by one or more processors and/or circuits in a media player:
reading multimedia data from a media storage device, wherein said multimedia data comprises compressed three-dimensional (3D) video data comprising a plurality of view sequences;
determining at least one video data transfer limitation of a connecting subsystem utilized to transfer said read video data to a video processing device that is used to playback said video data; and
decimating one or more of said plurality of view sequences based on said determination.

2. The method according to claim 1, wherein said decimation comprises temporal and/or spatial decimation.

3. The method according to claim 1, wherein said plurality of view sequences comprises sequences of stereoscopic left and right view reference frames or fields.

4. The method according to claim 3, comprising removing, during temporal decimation of said sequences of stereoscopic left and right views, corresponding frames in said sequences of stereoscopic left and right views.

5. The method according to claim 3, comprising removing, during temporal decimation of said sequences of stereoscopic left and right views, alternating frames in said sequences of stereoscopic left and right views.

6. The method according to claim 3, comprising removing, during spatial decimation of said sequences of stereoscopic left and right views, top or bottom fields in each frame of said sequences of stereoscopic left and right views.

7. The method according to claim 1, wherein said media storage device comprises a Blu-ray disc.

8. The method according to claim 1, wherein said connecting subsystem comprises a High-Definition Multimedia Interface (HDMI) based connection.

9. The method according to claim 1, wherein said decimated 3D video data is processed by said video processing device to reconstruct video data removed during said decimation.

10. The method according to claim 9, wherein a three-dimension (3D) output video is generated by said video processing device based on said reconstruction.

11. A system for video processing, the system comprising:
one or more circuits and/or processors for use in a media player, said one or more circuits and/or processors are operable to read multimedia data from a media storage device, wherein said multimedia data comprises compressed three-dimensional (3D) video data comprising a plurality of view sequences;
said one or more circuits and/or processors are operable to determine at least one video data transfer limitation of a connecting subsystem utilized to transfer said read video data to a video processing device that is used to playback said video data; and
said one or more circuits and/or processors are operable to decimate one or more of said plurality of view sequences based on said determination.

12. The system according to claim 1, wherein said decimation comprises temporal and/or spatial decimation.

13. The system according to claim 11, wherein said plurality of view sequences comprises sequences of stereoscopic left and right view reference frames or fields.

14. The system according to claim 13, said one or more circuits and/or processors are operable to remove, during temporal decimation, corresponding frames in said sequences of stereoscopic left and right views.

15. The system according to claim 13, said one or more circuits and/or processors are operable to remove, during temporal decimation, alternating frames in said sequences of stereoscopic left and right views.

16. The system according to claim 13, said one or more circuits and/or processors are operable to remove, during spatial decimation, top or bottom fields in each frame of said sequences of stereoscopic left and right views.

17. The system according to claim 11, wherein said media storage device comprises a Blu-ray disc.

18. The system according to claim 11, wherein said connecting subsystem comprises a High-Definition Multimedia Interface (HDMI) based connection.

19. The system according to claim 11, wherein said decimated 3D video data is processed by said video processing device to reconstruct video data removed during said decimation.

20. The system according to claim 19, wherein a three-dimension (3D) output video is generated by said video processing device based on said reconstruction.
